(19) United States
(12) Patent Application Publication
(10) Pub. No.: US 2018/0076441 A1
(43) Pub. Date: Mar. 15, 2018

(54) ELECTRODE HAVING LOCAL POROSITY DIFFERENCES, METHOD FOR MANUFACTURING SUCH AN ELECTRODE AND FOR THE USE THEREOF

(71) Applicant: Robert Bosch GmbH, Stuttgart (DE)

(72) Inventor: Harald Bauer, Ehningen (DE)

(21) Appl. No.: 15/702,322

(22) Filed: Sep. 12, 2017

(30) Foreign Application Priority Data
Sep. 13, 2016 (DE) 102016217390.1

(51) Int. Cl. H01M 4/04; H01M 10/0525; H01M 4/66; H01M 4/36

(52) U.S. Cl. CPC H01M 4/0404; H01M 10/0525; H01M 2004/021; H01M 4/364; H01M 4/043; H01M 4/662

(57) ABSTRACT

An electrode including at least one current collector and at least one active-material layer, the active-material layer including at least one first continuously configured area K including active-material particles P(A), and at least one second discontinuously configured area D including active-material particles P(B), the at least one discontinuously configured area D being surrounded by the continuously configured area K, and the discontinuously configured area D having a diameter of no more than double the layer thickness of the active-material layer.

### RELATED APPLICATION INFORMATION

The present application claims priority to and the benefit of German patent application no. 10 2016 217 390.1, which was filed in Germany on Sep. 13, 2016, the disclosure of which is incorporated herein by reference.

### FIELD OF THE INVENTION

The present invention relates to an electrode having local porosity differences in the active material and to a method for manufacturing such an electrode and for the use thereof.

### BACKGROUND INFORMATION

The performance, in particular the energy density of electrochemical energy storage systems such as lithium-ion batteries (LIB), depends essentially on the selection and the configuration of the electrodes in the cell. In principle, it is advantageous for the storage capacity of the cells when the electrodes may have a high portion of active material, and the portion of material which does not actively contribute to the energy storage, such as, for example, the material of the current collector, is reduced to a minimum. From an electrochemical perspective, the increase in the layer thickness of the active-material layer on the current collector resulting from this requirement is not constructive, however. It is known that at high C-rates, in particular, the reaction between the charge carriers from the electrolyte of the cell and the active material takes place essentially on the surface of the active-material layer, and only a small portion of charge carriers may diffuse more deeply into the active-material layer. In order to improve this diffusion, different structured active-material layers and their manufacture have been described in the related art.

EP 1 644 136, US 2012/0328942 A1, US 2013/0171527 A1 and US 2013/0050903 A1 discuss, for example, methods in which the active-material layer is made up of several layers having different porosities. Such methods require a disadvantageous, multi-step manufacturing method in which each layer must be applied individually.

M. Bayer discusses, in his dissertation on the topic “Development of Alternative Electrodes and Activation Concepts for Alkaline High-Performance Electrolysis” (University of Ulm, 2000), a method for manufacturing electrodes for electrolyzers which include funnel-shaped pores on the surface.

By way of the above discussed method, a better accessibility to underlying regions of the active-material layer is achieved, in principle. This advantage comes at the price of a reduction in the quantity of active material, however.

J. H. Daniel (Printed electronics—prospects and challenges for displays and sensing devices; presented at the Meeting of the Bay Area Chapter of the Society for Information Display; Dec. 15, 2009; San Jose, Calif.) discusses a method for manufacturing electrodes, which includes the coextrusion of two active materials having different porosities. In this case, the active-material compositions are imprinted onto the surface of a current collector next to each other in strips. This method accepts the fact, however, that the quantity of active material and, therefore, the energy density are reduced to an extent greater than necessary. In addition, an active-material composition containing a solvent is necessary for carrying out the print process.

### SUMMARY OF THE INVENTION

An object of the present invention is therefore to provide an electrode which improves the diffusion of the electrolyte, and the charge carriers contained therein, into the active-material layer of the electrode. The electrode should also be manufacturable using a simple manner/arrangement. This object is achieved by the present invention described in the following.

The present invention relates to an electrode including at least one current collector and at least one active-material layer, the active-material layer including at least one first continuously configured area K including active-material particles P(A), and at least one second discontinuously configured area D including active-material particles P(B), the at least one discontinuously configured area D being surrounded by continuously configured area K, and discontinuously configured area D having a diameter of no more than double the layer thickness of the active-material layer.

In this case, active-material particles P(A) and active-material particles P(B) include primary particles made up of active material A and active material B, and, if necessary, further additives such as conductive additives, binders, or solvents. Active-material particles P(A) and active-material particles P(B) are therefore agglomerates which are formed from the individual components and, in particular, include the primary particles made up of active material A and active material B, respectively. It is essential to the present invention that active-material particles P(A) and active-material particles P(B) have different porosities, the porosity of active-material particles P(B) being greater than the porosity of active-material particles P(A). This may be achieved by way of different measures which are known, in principle, to those skilled in the art. This will be described in greater detail in the description of the manufacturing method. In this way, the different porosities of active-material particles P(A) and active-material particles P(B) may be attained in that the primary particles—made up of active material A and active material B, respectively—differ with respect to particle size, particle shape, and/or particle type (type of the active material). The additives may also differ with respect to type and quantity in order to achieve a different porosity.

Active material A and active material B may be the same or differ from each other with respect to the shape and size of the primary particles and their chemical composition. If active materials A and B are identical, the different porosity of active-material particles P(A) and P(B) must therefore be attained by way of a suitable selection of the further additives.

In this case, active material A and active material B may be selected from the materials, known to those skilled in the art, which are suitable for manufacturing electrodes for electrochemical energy storage systems. This includes, for example, amorphous silicon, which may form alloy connections with lithium atoms, as the active material for the negative electrode of a lithium-ion battery. Carbon compounds such as, for example, graphite, are also options as the active material for negative electrodes. Lithiated intercalation compounds, for example, which are able to reversibly absorb and release lithium ions, may be utilized as the active material for the positive electrode of a lithium-ion battery. The positive active material may include a composite oxide or phosphate which contains at least one metal selected from the group made up of cobalt, magnesium, nickel, and lithium. In particular, LiMn₂O₄, LiFePO₄, Li₂MnO₃, Li_{1.17}Ni_{0.17}Co_{0.1}Mn_{0.56}O₂, LiCoO₂ and LiNiO₂ are to be emphasized as particular examples.

With respect to further areas of application of electrodes manufactured according to the present invention, in particular with respect to electrodes for fuel cells and electrolyzers, particulate compositions including graphite, activated charcoal, or carbon nanotubes are to be mentioned as further active materials.

The particle size of the primary particles is ideally adapted to the desired properties of the active material. For example, the primary particles have a mean particle size of 10 μm. In order to achieve a greater porosity of the active-material particles, in particular active-material particles P(B), a nearly spherical particle shape having a narrow particle size distribution is advantageous; as a result, the porosity of the densest sphere packing is formed as the lower limit defined by (26%). Porosities having an undefined magnitude may be attained by using aspherical bodies, for example, small plates, and small balls. In order to achieve a low porosity of the active-material particles, in particular active-material particles P(A), i.e., dense packings, compositions having a broad particle size distribution may be utilized. Gaps are formed between large particles in this case, which are filled by the smaller particles.

Suitable additives include, in particular, conductive additives and binders as well as porosity creators and solvents for creating porosities in the active-material particles.

Conductive carbon black, graphite, and carbon nanotubes, in particular, are to be emphasized as conductive additives. Binders may include a polymer material selected from polyvinylidene fluoride (PVDF), polytetrafluorethene (PTFE) styrene-butadiene copolymer (SBR), and ethylene propylene diene terpolymer (EPDM). Particularly, binder B may include at least PVDF and/or PTFE. In one specific embodiment, the binder includes PTFE. Due to the pronounced formation of fibrils, this binder may be used, particularly advantageously, for generating a paste-like, shapeable active-material composition.

As an additional component, the active-material composition in one specific embodiment may include at least one solid-state electrolyte, in particular an inorganic solid-state electrolyte, which is able to conduct cations, in particular lithium ions. According to the present invention, such solid inorganic lithium-ion conductors include crystalline, composite, and amorphous inorganic solid lithium-ion conductors. Crystalline lithium-ion conductors include, in particular, lithium-ion conductors of the perovskite type, lithium lanthanum titanate, lithium-ion conductors of the NASICON type, lithium-ion conductors of the LISICON and thio-LISICON types, as well as lithium-ion conducting oxides of the garnet type. The composite lithium-ion conductors include, in particular, materials which contain oxides and mesoporous oxides. Such solid inorganic lithium-ion conductors are described, for example, in an overview article written by Philippe Knauth, “Inorganic solid Li ion conductors: An overview,” Solid State Ionics, volume 180, editions 14-16, Jun. 25, 2009, pages 911-916. According to the present invention, all solid lithium-ion conductors which are described by C. Cao, et al. in “Recent advances in inorganic solid electrolytes for lithium batteries,” Front. Energy Res., 2014, 2:25, may also be included. In particular, the garnets described in EP1723080 B1 are also included, according to the present invention. The solid-state electrolyte may be utilized, in particular, in the form of particles having a mean particle diameter of ≧0.05 μm to ≦5 μm, which may be ≧0.1 μm to ≦2 μm. Provided the active-material composition includes a solid-state electrolyte, this may make up, for example, 0 weight percent to 50 weight percent, which may be 10 weight percent to 40 weight percent of the active-material composition.

Suitable solvents are, in particular, those which are suitable for dissolving or swelling the binder or binders. Examples worth mentioning are N—C₁₋₆-alkylpyrrolidone, in particular N-methylpyrrolidone and N-ethylpyrrolidone.

In addition, the solvent in one specific embodiment of the present invention may be selected in such a way that it influences the porosity of the active-material particles. For example, solvent mixtures may be utilized, which are able to dissolve the binder or binders and from which a solvent component may be removed in a targeted way in order to lower the solubility of the binder in the solvent mixture, while the further component or components of the solvent mixture initially remain in the active-material composition in order to increase the porosity thereof.

Active-material particles P(A) and active-material particles P(B) each include, independently of each other, approximately 70 weight percent to 98 weight percent—relative to the total weight—of primary active-material particles made up of active material A and B, respectively. Incidentally, active-material particles P(A) and active-material particles P(B) each include 2 weight percent to 30 weight percent—relative to the total weight—of additives, for example 1 weight percent to 10 weight percent of conductive additives, 1 weight percent to 10 weight percent of binders, and 0 to 10 weight percent of solvents.

The current collector of the electrode is made up of an electrically conductive material. Suitable materials from which the current collector may be formed are, for example, aluminum, copper, and nickel, and their alloys. The layer thickness of the current collector is not limited. The current collector may be configured planar in the form of a sheet or a foil. Since the current collector does not need to provide any stability-promoting properties and, otherwise, increases the weight of the electrode, a thin configuration in the form of a foil may be used. For example, the current collector has a layer thickness of 1 μm to 500 μm, in particular 5 μm to 200 μm.

An active-material layer is applied on at least one surface of the current collector. This includes a continuously configured area K which is applied on the surface of the current collector in a planar way, and includes active-material particles P(A). Continuously configured area K may be made up of active-material particles P(A). At least one discontinuously configured area D is embedded in this continuously configured area K. A plurality of discontinuously configured areas D may be embedded in continuously configured area K. Discontinuously configured area D includes active-material particles P(B). Discontinuously configured area D may be made up of active-material particles P(B). Due to the different porosities of active-material particles P(A) and active-material particles P(B), continuously configured area K, including active-material particles P(A), has a lower porosity than the at least one discontinuously configured area D including active-material particles P(B). The areas of high porosity in the at least one discontinuously configured area D allow for an easier diffusion of the charge carriers in the active-material layer, in particular an improved diffusion in areas of the active-material layer which are lower-lying as viewed from the surface of the electrode, while the areas having a low porosity (and, therefore, high portions of active material) provide for a high energy density and storage capacity.

The layer thickness of the active-material layer, including continuously configured area K and the at least one discontinuously configured area D, may be ≧50 μm and ≦500 μm. More particularly, the active-material layer may have a thickness of ≧100 μm to ≦400 μm, in particular ≧150 μm to ≦300 μm. These values relate to the layer thickness of an active-material layer which is applied on a current collector. The electrode according to the present invention includes at least one active-material layer and at least one current collector in this case. The thickness of the electrode according to the present invention is therefore composed of the individual layer thicknesses of these components.

In order to maintain a high portion of active material, which is available for energy storage, it may be provided to maintain the volumetric portion of the at least one discontinuously configured area D which may be low. For good diffusion properties of the electrode, it is advantageous when the volume of the individual discontinuously configured areas D is low and, in return, the number of discontinuously configured areas D is increased as necessary. The diameter of discontinuously configured areas D therefore corresponds, at the point of its greatest extension, to no more than double the layer thickness of the active-material layer. The active-material layer may include a plurality of discontinuously configured areas D, for example ≧10, which may be ≧50, in particular ≧100 areas D per square centimeter of the surface of the active-material layer.

The volumetric portion of active-material particles P(A) in the entire active-material layer may be greater than the volumetric portion of active-material particles P(B) therein. In particular, the active material layer includes, relative to the total volume, >50 volume percent of active-material particles P(A), which may be ≧60 volume percent of active-material particles P(A), which particularly may be ≧75 volume percent of active-material particles P(A).

In one specific embodiment, discontinuous areas D make up ≧50% of the total layer thickness, which may be ≧75%, relative to the thickness of the active-material layer. In one particularly specific embodiment, the at least one discontinuously configured area D, including active-material particles P(B), completely penetrates the active-material layer from the surface of the current collector up to the surface facing away from the current collector.

Active-material particles P(A) may differ from active-material particles P(B) with respect to their particle shape and/or size. For example, active-material particles P(A) include essentially no spherical particles, and active-material particles P(B) include essentially no aspherical particles. This essentially means that the particular particle shape makes up at least 90 weight percent, which may be 95 weight percent of the particles P(A) and P(B). Spherical particles are distinguished by the fact that the particle diameters of every spherical particle deviate from each other by ≦10%, in particular ≦5%, in three extensions lying orthogonally with respect to each other. In the case of aspherical particles within the scope of this present invention, the deviation is therefore >10%, in particular >30%, in at least one extension direction. Ball-shaped particles are examples of spherical particles. Elliptical particles are examples of aspherical particles.

In one specific embodiment, the aspherical active-material particles may be manufactured, for example, by producing a free-standing active-material foil of the desired active-material composition and subsequently reducing the size thereof, in a targeted manner, to the desired particle size. In this way, aspherical, essentially small plate-like particles may be obtained.

The electrode according to the present invention may be manufactured in an easy way with the aid of the method described in the following. The method includes the method steps:
a) providing at least one first active-material composition Z(A) including active-material particles P(A) and at least one second active-material composition Z(B) including active-material particles P(B);
b) providing a mixture G of the at least one first active-material composition Z(A) and the at least one second active-material composition Z(B);
c) applying mixture G on a substrate in order to form an active-material layer;
d) compacting and drying the at least one active-material layer, if necessary;
   the porosity of active-material particles P(A) being lower than the porosity of active-material particles P(B) and the portion of second active-material composition Z(B) in mixture G being less than the portion of first active-material composition Z(A). In one specific embodiment, a compaction of the active-material layer is carried out in method step d) and, after the compaction step, the porosity of active-material particles P(A) is less than the porosity of active-material particles P(B).

In a first step, an active-material composition Z(A) including active-material particles P(A), and at least one second active-material composition Z(B) including active-material particles P(B) are provided. The aforementioned definitions apply with respect to active-material particles P(A) and P(B). Active-material compositions Z(A) and Z(B) may include, in addition to active-material particles P(A) and active-material particles P(B), additives such as conductive additives, binders, or solvents, and form agglomerates of these components. The comments made above also apply similarly with respect to the additives. In one specific embodiment, active-material composition Z(A) is made up of active-material particles P(A) or agglomerates thereof, and active-material composition Z(B) is made up of active-material particles P(B) or agglomerates thereof. The porosity of active-material particles P(A) is lower than the porosity of active-material particles P(B). This property may be adjusted by way of a suitable selection of the active materials (in particular with respect to their shape and size, the particle size distribution and the chemical composition) and the additives (in particular their type and quantities).

In a second step, a mixture G of active-material compositions Z(A) and Z(B) is provided, the portion of second active-material composition Z(B) in mixture G being less than the portion of first active-material composition Z(A). In particular, mixture G includes, relative to the total weight of mixture G, >50 weight percent of active-material composition Z(A), which may be ≧60 weight percent of active-material composition Z(A), which particularly may be ≧75 weight percent of active-material composition Z(A).

Mixture G may be manufactured by using a conventional mixing method, provided the porosity of active-material particles P(A) and P(B) is not substantially changed as a result. A gravity mixer may be utilized, for example, in one specific embodiment.

Mixture G produced in this way is subsequently applied onto the surface of a substrate. In one specific embodiment, the substrate is the surface of a tool, e.g., the surface of a conveyor belt. This may be made of plastic. In this case, the active-material layer may be removed at the end of the manufacturing process as a free-standing active-material film. In this case, active-material particles P(A) and P(B) include at least one binder which was fibrillated in the presence of primary active-material particles A and B under the effect of shear forces, for example, in a jet mill. Such a method is known, for example, from EP 1 644 136, although it is not limited to this method. In order to prevent or reduce an adhesion of the active-material layer on the surface of the substrate, the method may be carried out at a temperature which lies below glass transition temperature T_{g} of the at least one binder. The active-material layer may be subsequently removed from the substrate as a free-standing active-material film and laminated onto a current collector, for example, at a temperature above the glass transition temperature of the binder.

In yet another specific embodiment, the substrate may also be the surface of a current collector. In this case, a free-standing active-material film is not produced, but rather an electrode is directly obtained.

The active-material layer may be subsequently compacted with the aid of a press, a ram, or a roller, which may be at a temperature which lies above glass transition temperature T_{g} of the at least one binder. This makes it possible to further influence the particle shape of particles P(A) and P(B). In one specific embodiment, active-material particles P(B) have a diameter before compaction that is up to 50% greater than the layer thickness of the active-material layer to be manufactured. If the desired layer thickness of the active-material layer is obtained by way of the compaction, the spherical active-material particles P(B), which protrude beyond the sought layer thickness of the active-material layer due to their size, are compressed. After the compaction step, a discontinuously configured area D is obtained, which is formed from active-material particles P(B) and has an approximately cylindrical shape. Spherical active-material particles P(B) therefore may have a particle diameter of 100% to 150%, in particular 110% to 130%, of the intended layer thickness of the finished active-material layer. The compaction step may take place additionally under the effect of heat, in order to support an adhesion of the binder to the surface of the current collector and to effectuate a permanent compaction. If the substrate is not the current collector, heat may be not input. Finally, the removal of solvent, which is possibly contained therein, may also take place in this step. This takes place, for example, at an elevated temperature and/or a reduced pressure.

The electrode according to the present invention may be advantageously utilized as an electrode in an electrochemical energy storage system. Suitable electrochemical energy storage systems include, in particular, lithium-ion batteries and hybrid supercapacitors. The subject matter of the present invention is therefore also such an electrochemical energy storage system, in particular lithium-ion batteries, including at least one electrode according to the present invention.

The method according to the present invention makes it possible to manufacture electrodes which include layers of active materials which have areas of increased porosity. These areas are uniformly distributed in the active-material layers and provide for a good diffusion of the charge carriers from the electrolyte of the energy storage systems also into lower-lying areas of the active-material layer, as viewed from the surface of the electrode. In this way, the active material is also better utilized in the case of large active-material thicknesses and high C-rates, and the energy density of the energy store is increased. At the same time, the method may be implemented using a simple manner and/or arrangement and requires only a single coating step.

Specific embodiments of the present invention are described in greater detail with reference to the drawings and the following description.

### BRIEF DESCRIPTION OF THE DRAWINGS

FIG. 1 shows the side view of a schematic section of a conventional electrode precursor.

FIG. 2 shows the side view a schematic section of an electrode precursor according to the present invention.

FIG. 3a shows a schematic representation of an electrode according to the present invention.

FIG. 3b shows a schematic representation of the diffusion paths of charge carriers in the electrode according to FIG. 3a.

FIG. 4 shows a top view of the electrode according to the present invention, according to FIG. 3.

### DETAILED DESCRIPTION

In one exemplary specific embodiment, the same material, for example, LiCoO₂, is used as active material A 5 and active material B 7. Ideally, active materials A 5 and B 7 differ with respect to their particle structure, particle size, and/or the particle size distribution. Active material B 7 may have a spherical structure, and has a narrow particle size distribution and a mean particle size that is greater than the mean particle size of the particles of active material A 5. The particle size distribution of the particles of active material A 5 is broader, and so this permits a denser packing of the particles.

Active-material particles P(A) 4 (agglomerates), including 90 weight percent of primary particle A, 5 weight percent of conductive carbon black, and 5 weight percent of PVDF, are produced by fibrillating the PVDF binder out of the composition in a jet mill. Active-material particles P(B) 6 (agglomerates), including 80 weight percent of primary particle A, 10 weight percent of conductive carbon black, and 10 weight percent of PVDF, are produced by fibrillating the PVDF binder out of the composition in a jet mill. Active-material particles P(A) 4 have a mean particle diameter of 100 μm. Active-material particles P(B) 6 have a mean particle diameter of 130 μm.

Active-material particles P(A) 4 and P(B) 6 are processed in a gravity mixer to form a homogeneous mixture G. Mixture G includes 60 weight percent to 70 weight percent of active-material particle P(A) 4 and 30 weight percent to 40 weight percent of active-material particle P(B) 6. Mixture G is applied, as current collector 2, on an aluminum foil having a layer thickness of 10 μm. An active-material layer 3 having a layer thickness of 130 μm is applied thereon. This is subsequently compacted, at 70° C., to a layer thickness of 100 μm with the aid of a roller. In this compaction step, the previously essentially spherical structure of active-material particles P(A) 4 and P(B) 6 is compressed. Since the mean diameter of active-material particles P(B) 6 is considerably greater than the attained layer thickness, areas are attained in active-material layer 3, which are formed from active-material particles P(B) 6 and have an approximately cylindrical structure.

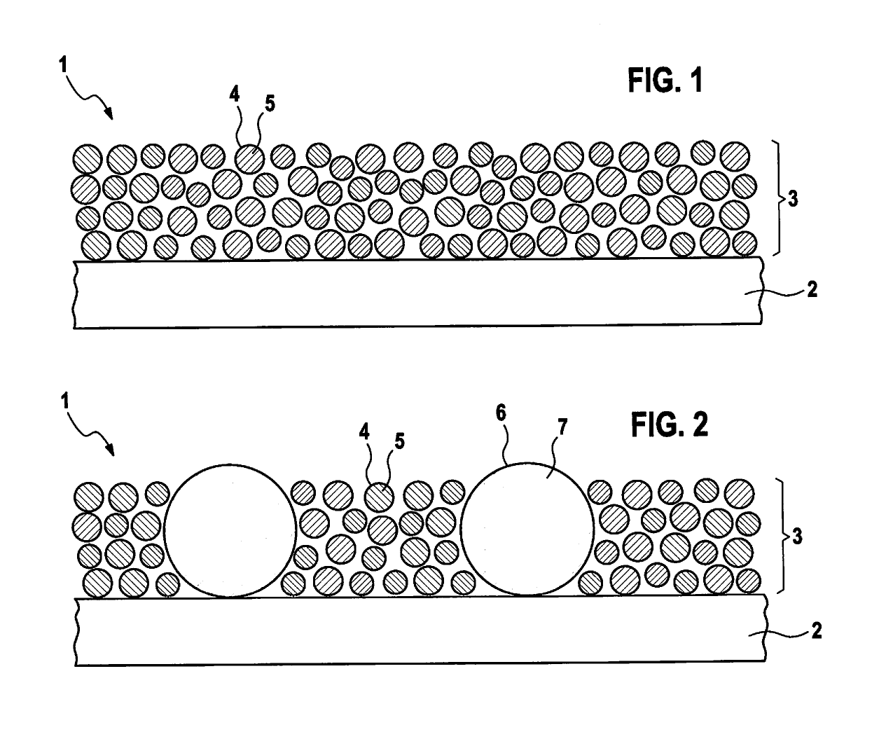

FIG. 1 shows the side view of a conventional electrode precursor 1 before compaction, including a current collector 2, onto which active-material particles P(A) 4 are applied and form active-material layer 3. Active-material particles P(A) 4 include active material A 5.

FIG. 2 shows the side view of an electrode precursor 1 according to the present invention before compaction, including a current collector 2, onto which a mixture G of active-material particles P(A) 4 and active-material particles P(A) 6 is applied and forms an active-material layer 3. Active-material particles P(A) 4 include active material A 5. Active-material particles P(B) 6 include active material B 7.

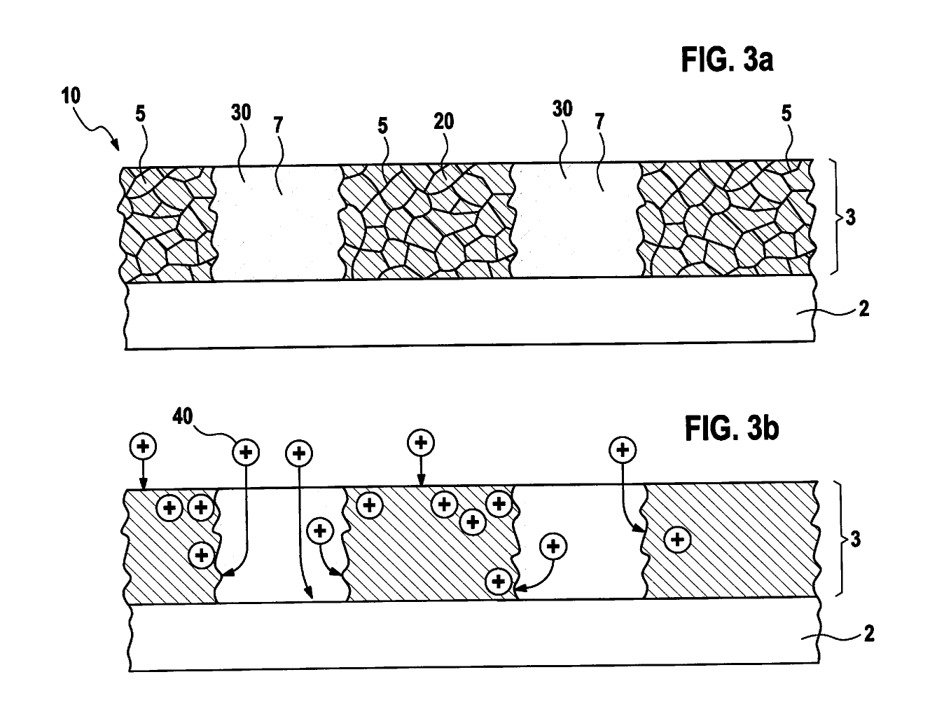

FIG. 3a shows the side view of an electrode 10 according to the present invention after compaction. Due to the compaction, an active-material layer 3 of a uniform thickness has been formed on current collector 2. Continuously configured area K 20 including active material A 5 has a lower porosity than discontinuously configured area D 30 including active material B 7.

FIG. 3b shows that the diffusion of charge carriers 40 of the electrolyte composition, in particular the lithium ions, which may be takes place in this approximately cylindrical, discontinuously configured area D 30 having a higher porosity. In this way, it is possible that charge carriers 40 react not only on the surface with active material A 5 in continuously configured area K 20, but also penetrate more deeply into active-material layer 3. The energy density of the cell is effectively increased.

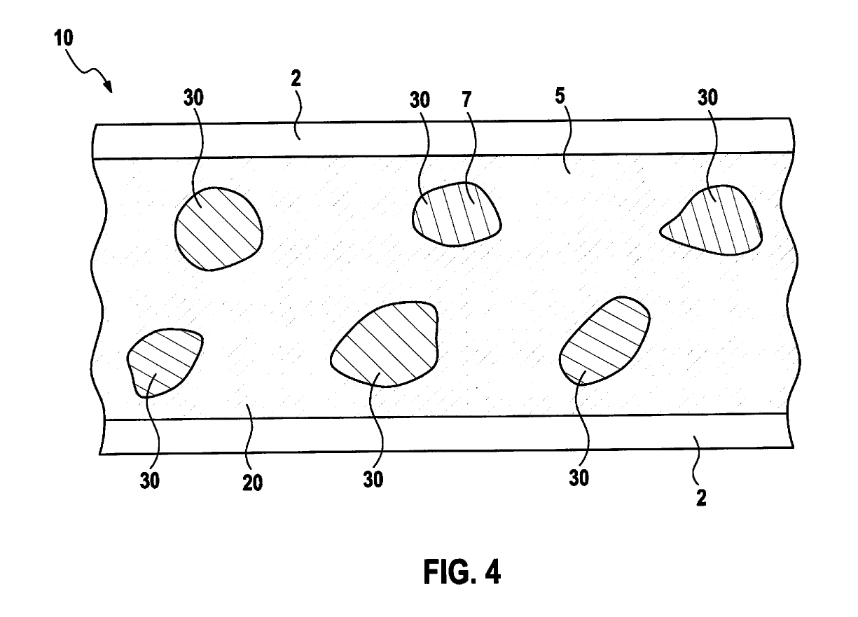

FIG. 4 shows the top view of electrode 10 according to the present invention, according to FIG. 3. It is apparent that discontinuously configured areas D 30 (including active material B 7) are embedded in continuously configured area K 20 (including active material A 5).

What is claimed is:

1. An electrode, comprising:
at least one current collector; and
at least one active-material layer;
wherein the active-material layer includes at least one first continuously configured area including first active-material particles, and at least one second discontinuously configured area including second active-material particles, the at least one discontinuously configured area being surrounded by the continuously configured area, and the discontinuously configured area having a diameter of no more than double the layer thickness of the active-material layer.

2. The electrode of claim 1, wherein the continuously configured area, including the first active-material particles, has a lower porosity than the at least one discontinuously configured area including the second active-material particles.

3. The electrode of claim 1, wherein the volumetric portion of the first active-material particles in the entire active-material layer is greater than the volumetric portion of the second active-material particles.

4. The electrode of claim 1, wherein the at least one discontinuously configured area, including the second active-material particles, completely penetrates the active-material layer from the surface of the current collector up to the surface facing away from the current collector.

5. The electrode of claim 1, wherein the first active-material particles include essentially no spherical particles and the second active-material particles include essentially no aspherical particles.

6. A method for manufacturing an electrode, the method comprising:
providing at least one first active-material composition including first active-material particles and at least one second active-material composition including second active-material particles;
providing a mixture of the at least one first active-material composition and the at least one second active-material composition
applying the mixture on a substrate to form an active-material layer;
compacting and drying the at least one active-material layer, if necessary;
wherein the porosity of the first active-material particles is lower than the porosity of the second active-material particles, and
wherein the portion of the second active-material composition in the mixture is less than the portion of the first active-material composition.

7. The method of claim 6, wherein the substrate is at least one surface of a current collector.

8. The method of claim 6, wherein the second active-material particles have a diameter which is up to 50% greater than the layer thickness of the active-material layer to be manufactured, and the desired layer thickness of the active-material layer is adjusted with a compaction step.

9. The method of claim 6, wherein the electrode includes:
at least one current collector; and
at least one active-material layer;
wherein the active-material layer includes at least one first continuously configured area including the first active-material particles, and at least one second discontinuously configured area including second active-material particles, the at least one discontinuously configured area being surrounded by the continuously configured area, and the discontinuously configured area having a diameter of no more than double the layer thickness of the active-material layer.

10. The electrode of claim 1, wherein the electrode is used in an electrochemical energy storage system.

11. An electrochemical energy storage system, comprising:
an electrode, including:
at least one current collector; and
at least one active-material layer;
wherein the active-material layer includes at least one first continuously configured area including first active-material particles, and at least one second discontinuously configured area including second active-material particles, the at least one discontinuously configured area being surrounded by the continuously configured area, and the discontinuously configured area having a diameter of no more than double the layer thickness of the active-material layer.

12. The electrochemical energy storage system of claim 11, wherein the electrochemical energy storage system includes lithium-ion batteries.
